(19) United States
(12) Patent Application Publication
(10) Pub. No.: US 2023/0294643 A1
(43) Pub. Date: Sep. 21, 2023

(54) VEHICLE TANK

(71) Applicant: TOYODA GOSEI CO., LTD., Kiyosu-shi (JP)

(72) Inventors: Shinichiro WADA, Aichi-ken (JP); Kenichiro KANEKO, Aichi-ken (JP)

(21) Appl. No.: 18/183,239

(22) Filed: Mar. 14, 2023

(30) Foreign Application Priority Data
Mar. 18, 2022 (JP) 2022-043367

(51) Int. Cl. B60S 1/50; B60S 1/48; B65D 81/38

(52) U.S. Cl. CPC B60S 1/50; B60S 1/487; B65D 81/38

(57) ABSTRACT

A vehicle tank includes a first housing portion configured to house a first liquid for cleaning a cleaning object, and a second housing portion configured to receive a second liquid heated outside by heat exchange with a heating unit of a vehicle and house the second liquid which is received. A first wall defining the first housing portion and a second wall defining the second housing portion have a common wall shared by the first housing portion and the second housing portion.

### CROSS-REFERENCE TO RELATED APPLICATION

This application is based on and claims priority under 35 USC 119 from Japanese Patent Application No. 2022-043367 filed on Mar. 18, 2022.

### TECHNICAL FIELD

The present disclosure relates to a vehicle tank.

### BACKGROUND ART

With respect to a vehicle tank, there has been a technique of warming a cleaning liquid housed in the vehicle tank for the purpose of, for example, deicing a front window of a vehicle or improving cleaning efficiency. For example, JP-A-2009-184524 discloses a technique of causing engine cooling water to flow into a heat exchanger disposed in a tank for housing washer fluid, and heating the washer fluid by heat exchange between the engine cooling water and the washer fluid.

In JP-A-2009-184524, however, the heat exchanger needs to be provided in the tank. Therefore, the volume of the cleaning liquid which can be housed in the tank is reduced by the volume of the heat exchanger occupied in the tank.

### SUMMARY OF INVENTION

The present disclosure can be implemented in the following forms.

(1) According to an aspect of the present disclosure, there is provided a vehicle tank, including: a first housing portion configured to house a first liquid for cleaning a cleaning object; and a second housing portion configured to receive a second liquid heated outside by heat exchange with a heating unit of a vehicle and house the second liquid which is received, in which a first wall defining the first housing portion and a second wall defining the second housing portion have a common wall shared by the first housing portion and the second housing portion.

According to the aspect, the first liquid housed in the first housing portion can be heated by the second liquid housed in the second housing portion via the common wall. Therefore, the first liquid in the first housing portion can be heated without disposing a heat exchanger in the first housing portion.

(2) In the aspect described above, the vehicle tank further include a heat-insulating wall which surrounds a periphery of the first housing portion and the second housing portion, and insulates the first housing portion and the second housing portion from an outside. According to the aspect, since the first housing portion and the second housing portion can be insulated from the outside by the heat-insulating wall, the first liquid in the first housing portion can be heated more effectively by the second liquid in the second housing portion.

(3) In the aspect described above, the first housing portion has a first opening which opens in a first direction, the second housing portion has a second opening which opens in the first direction, the vehicle tank further comprises a lid member configured to close the first opening and the second opening, and the lid member has at least one of a first communication port through which an inside of the first housing portion communicates with the outside and a second communication port through which an inside of the second housing portion communicates with an outside. According to the aspect, the first liquid can be caused to flow into and out of the first housing portion via the first communication port, and the second liquid can be caused to flow into and out of the second housing portion via the second communication port. Therefore, for example, even if the first communication port and the second communication port are not provided to penetrate the first wall and the second wall, it is possible to easily cause each liquid to flow into and out of the first housing portion and the second housing portion.

(4) In the aspect described above, the lid member includes a heat-insulating portion configured to insulate the first housing portion and the second housing portion from the outside. According to the aspect, even when the first opening and the second opening are provided, the first housing portion and the second housing portion can be effectively insulated from the outside by the lid member.

(5) In the aspect described above, the periphery of the first housing portion is surrounded by the second housing portion. According to the aspect, the heat of the second liquid in the second housing portion can be easily transferred to the first liquid in the first housing portion, and the heat dissipation from the inside of the first housing portion to the outside can be further limited. Therefore, the first liquid in the first housing portion can be heated more effectively by the second liquid in the second housing portion.

(6) In the aspect described above, the second wall has a wall portion different from the common wall, and at least a portion of the common wall is thinner than the wall portion. According to the aspect, the heat of the second liquid in the second housing portion is easily transferred to the first liquid in the first housing portion via the common wall. Therefore, the first liquid in the first housing portion can be heated more effectively by the second liquid in the second housing portion.

The present disclosure can be realized in various forms such as a vehicle including a vehicle tank, in addition to the form as the vehicle tank described above.

### BRIEF DESCRIPTION OF DRAWINGS

FIG. 1 is a perspective view illustrating a schematic configuration of a vehicle tank according to a first embodiment.

FIG. 2 is a cross-sectional view taken along line II-II in FIG. 1.

FIG. 3 is a cross-sectional view taken along line III-III in FIG. 1.

FIG. 4 is a cross-sectional view taken along line IV-IV in FIG. 1.

FIG. 5 is a cross-sectional view taken along line V-V in FIG. 1.

FIG. 6 is a cross-sectional view of a vehicle tank according to a second embodiment.

FIG. 7 is a cross-sectional view of a vehicle tank according to a third embodiment.

### DESCRIPTION OF EMBODIMENTS

### A. First Embodiment

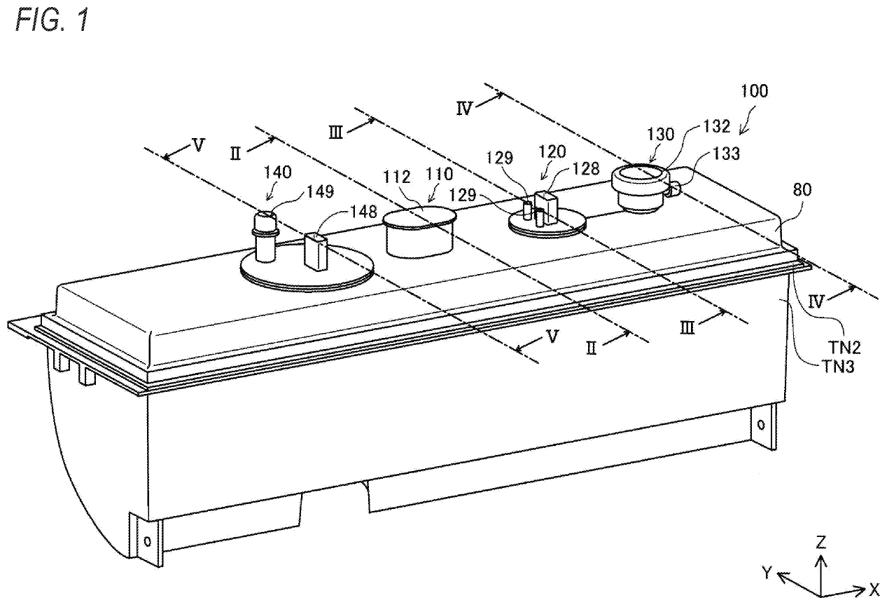

FIG. 1 is a perspective view illustrating a schematic configuration of a vehicle tank 100 according to a first embodiment. FIG. 1 illustrates arrows along X, Y, and Z directions orthogonal to each other. The X, Y, and Z directions are directions along an X axis, a Y axis, and a Z axis, which are three spatial axes orthogonal to each other, and each of the X, Y, and Z directions includes both a direction on one side and a direction opposite thereto along the X axis, the Y axis, and the Z axis. The X axis and the Y axis are axes along a horizontal plane, and the Z axis is an axis along a vertical line. Other drawings also illustrate arrows along the X, Y, and Z directions as appropriate. The X, Y, and Z directions in FIG. 1 and the X, Y, and Z directions in other drawings represent the same direction. Hereinafter, the +Z direction is also referred to as “upper”, and the −Z direction is also referred to as “lower”.

The vehicle tank 100 is provided in a vehicle (not illustrated). The vehicle tank 100 houses a first liquid and a second liquid therein. The first liquid refers to a liquid for cleaning a cleaning object. The first liquid in the present embodiment is also referred to as a cleaning liquid or a washer fluid, and is configured as a liquid containing a surfactant, alcohol (for example, methanol or ethanol), or the like. The cleaning object of the first liquid may be any object such as a front window or a rear window of the vehicle, a headlamp, various sensors or cameras for detecting a pedestrian or an object during traveling, or the like. The second liquid is heated outside the vehicle tank 100 by heat exchange with a heating unit of the vehicle, and is used to heat the first liquid. In the present embodiment, as the second liquid, a coolant for performing cooling and temperature adjustment of the heating unit of the vehicle is used. The object to be cooled by the second liquid, that is, the heating unit to be subjected to cooling or temperature adjustment by the second liquid may be an engine, a motor, an inverter, a battery pack, a control computer, or the like mounted on the vehicle.

In the vehicle, the vehicle tank 100 functions as a part of a cleaning system including a nozzle or the like for discharging the cleaning liquid, and as a part of a cooling system of a water-cooling type including a heat exchange mechanism such as a radiator. More specifically, the vehicle tank 100 functions as a cleaning liquid tank for housing the cleaning liquid in the cleaning system, and functions as a coolant reserve tank for housing the coolant in the cooling system. The vehicle provided with the vehicle tank 100 may be, for example, a gasoline vehicle or a diesel vehicle, or may be a battery electric vehicle (BEV), a hybrid electric vehicle (HEV), a plug-in hybrid electric vehicle (PHEV), or a fuel cell electric vehicle (FCEV).

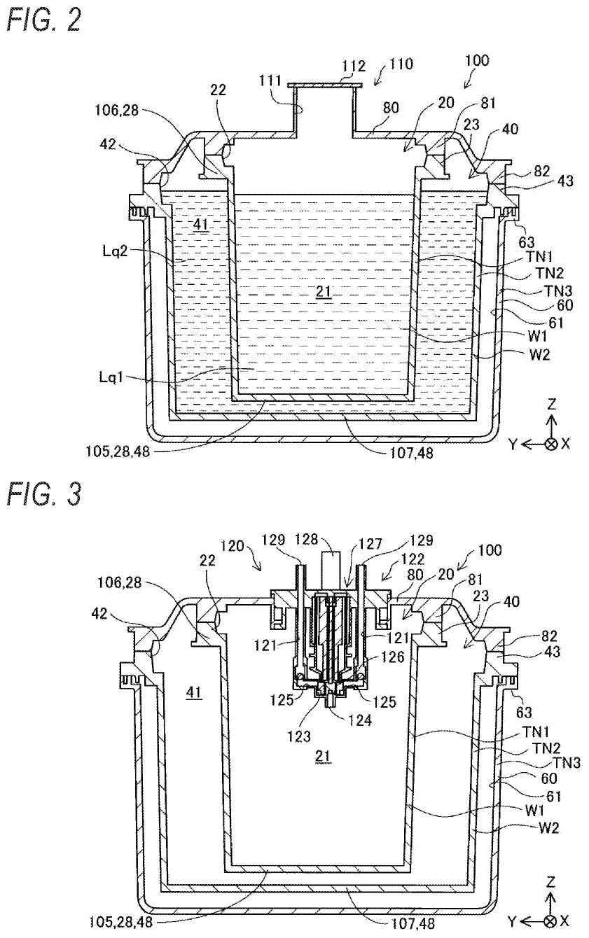

FIG. 2 is a cross-sectional view taken along line II-II in FIG. 1. As illustrated in FIG. 2, the vehicle tank 100 includes a first housing portion 20 and a second housing portion 40. Further, the vehicle tank 100 according to the present embodiment includes a heat-insulating wall 60 and a lid member 80. FIG. 2 schematically illustrates the first liquid Lq1 and the second liquid Lq2 housed in the vehicle tank 100.

The first housing portion 20 contains the first liquid described above. The first housing portion 20 is defined by a first wall 28, and has a first chamber 21 for housing the first liquid therein. More specifically, in the present embodiment, the first housing portion 20 is formed by a heat-retention tank TN1, and the first wall 28 is formed by a wall W1 of the heat-retention tank TN1. The heat-retention tank TN1 is formed of, for example, polypropylene (PP), glass fiber-reinforced polypropylene (GFPP), or the like. In the present embodiment, the heat-retention tank TN1 is formed in a recessed shape opening toward the +Z direction as a whole. Therefore, the first housing portion 20 has a recessed shape opening toward the +Z direction as a whole, and has a first opening 22 opening toward the +Z direction. The heat-retention tank TN1 has a flange-shaped first flange portion 23 at the upper end portion thereof. Hereinafter, the direction in which the first opening 22 is opened is also referred to as a first direction. That is, in the present embodiment, the first direction refers to the +Z direction.

The second housing portion 40 receives the second liquid described above and houses the received second liquid. The second housing portion 40 is defined by a second wall 48, and has a second chamber 41 for housing the second liquid therein. The second housing portion 40 in the present embodiment has a second opening 42 which opens in the first direction.

More specifically, the second housing portion 40 in the present embodiment is formed by a heating tank TN2 and the heat-retention tank TN1 described above. The heating tank TN2 is formed of, for example, PP, GFPP, or the like similarly to the heat-retention tank TN1. In the present embodiment, the heating tank TN2 has a recessed shape opening toward the +Z direction as a whole, and has a second flange portion 43 formed in a flange shape at the upper end portion thereof. The second housing portion 40 has an outer dimension larger than that of the first housing portion 20 in the X direction and the Y direction. In the heating tank TN2, the heat-retention tank TN1 described above is inserted into the opening of the recess of the heating tank TN2 from above such that a space is formed between the wall W1 and a wall W2 of the heating tank TN2. As a result, the second wall 48 is formed by a portion of the wall W1 inserted into the heating tank TN2 and the wall W2, and the second housing portion 40 is defined to surround the periphery of the first housing portion 20. More specifically, in the present embodiment, the periphery of the first housing portion 20 in the X direction and the Y direction and the periphery of the bottom portion of the first housing portion 20 are surrounded by the second housing portion 40. The second opening 42 described above is formed in the upper portion of the second housing portion 40 to surround the first opening 22 when viewed along the Z direction.

The first wall 28 and the second wall 48 described above have a common wall 105. The common wall 105 is a wall shared by the first housing portion 20 and the second housing portion 40 among the first wall 28 and the second wall 48, and is a wall defining both the first housing portion 20 and the second housing portion 40. In the present embodiment, a portion of the wall W1 housed in the heating tank TN2 corresponds to the common wall 105.

The first wall 28 in the present embodiment includes, in addition to the common wall 105, a first wall portion 106 different from the common wall 105. It can also be said that the first wall portion 106 is a portion of the first wall 28 which does not define the second housing portion 40. In the present embodiment, the upper end portion of the first wall 28 including the first flange portion 23 in the first wall 28 corresponds to the first wall portion 106. The second wall 48 according to the present embodiment includes a second wall portion 107 different from the common wall 105 in addition to the common wall 105. It can also be said that the second wall portion 107 is a portion of the second wall 48 which does not define the first housing portion 20. In the present embodiment, the wall W2 of the second wall 48 corresponds to the second wall portion 107. Hereinafter, the second wall portion 107 may be simply referred to as a “wall portion”.

As illustrated in FIG. 2, in the present embodiment, the heat-retention tank TN1 is inserted into the heating tank TN2, so that the heat-retention tank TN1 is housed in the heating tank TN2 such that the first flange portion 23 is located above the upper end portion of the heating tank TN2. In another embodiment, the heat-retention tank TN1 may be housed in the heating tank TN2 such that the first flange portion 23 is located below the upper end portion of the heating tank TN2. That is, the entire heat-retention tank TN1 may be housed in the heating tank TN2. In this case, the periphery of the first housing portion 20 in the X direction and the Y direction is surrounded by the second housing portion 40 over the entire range of the first housing portion 20 in the Z direction. In this case, the first wall 28 includes only the common wall 105 and does not include the first wall portion 106.

The heat-insulating wall 60 is a portion which surrounds the periphery of the first housing portion 20 and the second housing portion 40 and insulates the first housing portion 20 and the second housing portion 40 from the outside. In the present embodiment, the heat-insulating wall 60 insulates the first housing portion 20 and the second housing portion 40 from the outside by air in a heat-insulating chamber 61 to be described later.

More specifically, in the present embodiment, the heat-insulating wall 60 is formed by a wall of the heat-insulating tank TN3. The heat-insulating tank TN3 is formed of, for example, PP, GFPP, or the like similarly to the first housing portion 20 and the second housing portion 40. The heat-insulating tank TN3 according to the present embodiment has a shape opening in the first direction, and has a flange-shaped third flange portion 63 at the upper end portion thereof. The heating tank TN2 housing the heat-retention tank TN1 described above is inserted into the opening of the recess of the heat-insulating tank TN3 from above such that the lower surface of the second flange 43 and the upper surface of the third flange 63 are in contact with each other and a space is formed between the wall W2 and the heat-insulating wall 60. As a result, the heat-insulating chamber 61 described above is formed between the wall W2 and the heat-insulating wall 60, and the periphery of the first housing portion 20 and the second housing portion 40 is surrounded by the heat-insulating wall 60. More specifically, the periphery of the second housing portion 40 in the X direction and the Y direction and the periphery of the bottom portion of the second housing portion 40, surrounding the periphery of the first housing portion 20, are surrounded by the heat-insulating wall 60.

The second flange portion 43 and the third flange portion 63 are joined to each other by, for example, hot plate welding, vibration welding, laser welding, or the like. By joining the second flange part 43 and the third flange part 63, the airtightness of the heat-insulating chamber 61 is increased, and the first housing portion 20 and the second housing portion 40 can be insulated from the outside more effectively by the heat-insulating wall 60. The airtightness of the heat-insulating chamber 61 is only required to be secured to such an extent that heat dissipation from the first housing portion 20 or the second housing portion 40 to the outside can be limited. For example, a gap may be formed between the second flange portion 43 and the third flange portion 63 or the like. In other embodiments, the second flange part 43 and the third flange part 63 may be joined to each other by, for example, an adhesive, or the second flange part 43 and the third flange part 63 may not be joined to each other.

As illustrated in FIG. 2, in the present embodiment, the heating tank TN2 is inserted into the heat-insulating tank TN3, so that the heat-retention tank TN1 and the heating tank TN2 are housed in the heat-insulating tank TN3 such that the first flange 23 and the second flange 43 are positioned above the upper end portion of the heat-insulating tank TN3. In another embodiment, the heat-retention tank TN1 and the heating tank TN2 may be housed in the heat-insulating tank TN3 such that the first flange 23 and the second flange 43 are located below the upper end portion of the heat-insulating tank TN3. That is, the heat-retention tank TN1 and the heating tank TN2 may be entirely housed in the heat-insulating tank TN3. In this case, the periphery of the first housing portion 20 and the second housing portion 40 in the X direction and the Y direction is surrounded by the heat-insulating wall 60 over the entire range of the first housing portion 20 and the second housing portion 40 in the Z direction.

The lid member 80 is a member which closes the first opening 22 and the second opening 42. The lid member 80 is formed of, for example, PP, GFPP, or the like similarly to the heat-retention tank TN1 and the heating tank TN2. The lid member 80 according to the present embodiment has a recessed shape opening downward as a whole. The lid member 80 is provided with a first protrusion 81 and a second protrusion 82 protruding downward at positions corresponding to the first flange portion 23 and the second flange portion 43 in the X direction and the Y direction, respectively. The lower portion of the first protrusion 81 and the upper portion of the first flange portion 23 are welded to the lower portion of the second protrusion 82 and the upper portion of the second flange portion 43, respectively, by hot plate welding, vibration welding, laser welding, or the like. Thus, the lid member 80 is fixed to the upper portions of the first housing portion 20 and the second housing portion 40 to close the first opening 22 and the second opening 42. The lid member 80 is preferably sealed to the first housing portion 20 and the second housing portion 40 in a liquid-tight manner.

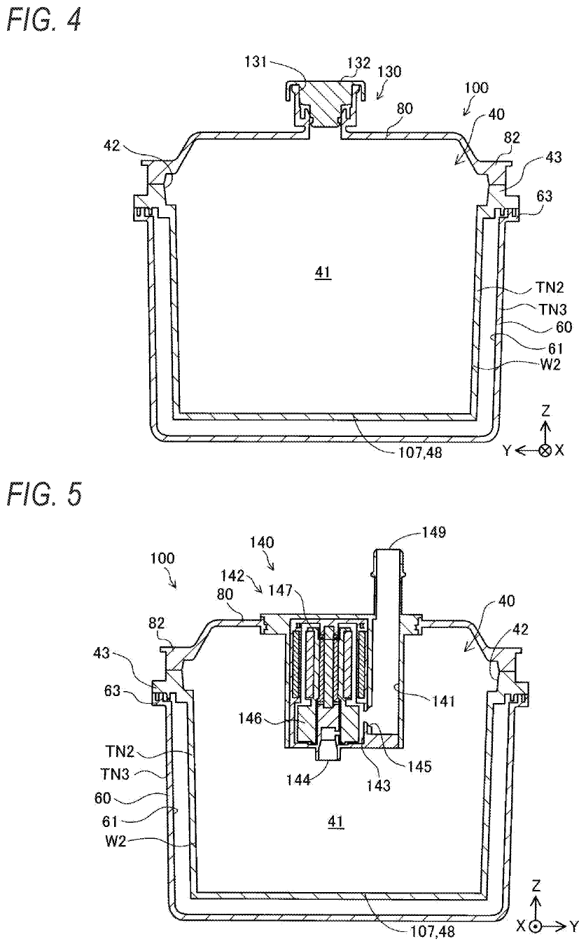

FIG. 3 is a cross-sectional view taken along line III-III in FIG. 1. FIG. 4 is a cross-sectional view taken along line IV-IV in FIG. 1. FIG. 5 is a cross-sectional view taken along line V-V in FIG. 1. In FIGS. 3 to 5, the first liquid Lq1 and the second liquid Lq2 illustrated in FIG. 2 are omitted. As illustrated in FIGS. 1 to 5, the lid member 80 according to the present embodiment is provided with a first inflow portion 110 and a second inflow portion 130 as inflow portions for causing the first liquid and the second liquid to flow into the vehicle tank 100 from the outside. The lid member 80 is provided with a first outflow portion 120 and a second outflow portion 140 as outflow portions for causing the first liquid and the second liquid to flow out from the inside of the vehicle tank 100 to the outside. Hereinafter, the inflow portion and the outflow portion are also collectively referred to as communication portions. As will be described later, each of the communication portions according to the present embodiment has one of a first communication port through which the inside of the first housing portion 20 communicates with the outside of the vehicle tank 100 and a second communication port through which the inside of the second housing portion 40 communicates with the outside of the vehicle tank 100.

The first inflow portion 110 illustrated in FIGS. 1 and 2 includes a first inlet 111 and a first cap 112 which closes the first inlet 111. The first inlet 111 is a communication port for causing the first liquid to flow into the first housing portion 20, and corresponds to the first communication port described above. The first inlet 111 according to the present embodiment is open upward. The first cap 112 is configured to be attachable to and detachable from the first inlet 111, and is attached to the upper portion of the first inlet 111. The first liquid is injected from the outside into the first housing portion 20 via the first inlet 111 in a state where the first cap 112 is removed from the first inlet 111. As a result, the first liquid is replenished into the first housing portion 20.

The first outflow portion 120 illustrated in FIGS. 1 and 3 includes two first flow paths 121 and a first pump 122. One end of each first flow path 121 is disposed outside the first housing portion 20 and functions as a first outlet 129. The first outlet 129 is a communication port for allowing the first liquid to flow out of the first housing portion 20, and corresponds to the first communication port described above. The first outlet 129 according to the present embodiment is located above the lid member 80. The other end of each first flow path 121 is connected to a first discharge port 125 of the first pump 122 to be described later.

As illustrated in FIG. 3, the first pump 122 has a first liquid chamber 123, a first suction port 124 for suctioning the first liquid in the first chamber 21 into the first liquid chamber 123, a first discharge port 125 for discharging the first liquid in the first liquid chamber 123 to the first flow path 121, a first impeller 126 disposed in the first liquid chamber 123, a first motor 127 connected to the first impeller 126, and a first connector 128 configured as a bipolar connector. The first motor 127 is driven by electric power supplied via wiring (not illustrated) connected to the first connector 128, and rotates the first impeller 126 in the first liquid chamber 123. The first pump 122 suctions the first liquid in the first chamber 21 into the first liquid chamber 123 via the first suction port 124 and discharges the first liquid into the first flow path 121 via the first discharge port 125 by the rotation of the first impeller 126. The first pump 122 according to the present embodiment is configured to discharge the first liquid to the first flow path 121 via one of the two first discharge ports 125 according to the direction of rotation of the first motor 127.

The first outlet 129 described above is connected to a nozzle (not illustrated) for discharging the cleaning liquid via a first piping portion (not illustrated) for causing the first liquid to flow. The first piping portion is constituted by, for example, a rubber hose or the like. The first liquid in the first housing portion 20 is discharged from the nozzle via the first outlet 129 and the first piping portion by driving the first pump 122. For example, a plurality of nozzles may be connected to one first outlet 129, and nozzles used for cleaning may be switchable by a valve mechanism provided in the first piping portion or the like. In another embodiment, the number of first outlets 129 may be, for example, one or three or more.

The second inflow portion 130 illustrated in FIGS. 1 and 4 includes a second inlet 131 and a second cap 132 which closes the second inlet 131. The second inlet 131 is a communication port for causing the second liquid to flow into the second housing portion 40, and corresponds to the second communication port described above. The second inlet 131 according to the present embodiment is open upward. The second cap 132 is configured to be attachable to and detachable from the second inlet 131, and is attached to the second inlet 131 by being inserted into the second inlet 131 from above. As illustrated in FIG. 1, the second cap 132 in the present embodiment has a connection port 133. The connection port 133 is configured to be connectable to a second piping portion (not illustrated) for causing the second liquid to flow. The second piping portion is constituted by, for example, a rubber hose or the like. The second housing portion 40 receives the second liquid heated by heat exchange with the heating unit of the vehicle via the second piping portion, the connection port 133, and the second inlet 131. In addition, by injecting the second liquid into the second housing portion 40 via the second inlet 131 in a state where the second cap 132 is detached from the second inlet 131, it is also possible to newly replenish the second housing portion 40 with the second liquid.

The second outflow portion 140 illustrated in FIGS. 1 and 5 includes a second flow path 141 and a second pump 142. One end of the second flow path 141 is disposed outside the second housing portion 40 and functions as a second outlet 149. The second outlet 149 is a communication port for allowing the second liquid to flow out from the inside of the second housing portion 40, and corresponds to the second communication port described above. The second outlet 149 according to the present embodiment is located above the lid member 80. The other end of the second flow path 141 is connected to a second discharge port 145 of the second pump 142 to be described later.

The second pump 142 has a second liquid chamber 143, a second suction port 144 for suctioning the second liquid in the second chamber 41 into the second liquid chamber 143, a second discharge port 145 for discharging the second liquid in the second liquid chamber 143 to the second flow path 141, a second impeller 146 disposed in the second liquid chamber 143, a second motor 147 connected to the second impeller 146, and a second connector 148. The second connector 148 is not illustrated in FIG. 5 but illustrated in FIG. 1. The second motor 147 is driven by electric power supplied via wiring (not illustrated) connected to the second connector 148, and rotates the second impeller 146 in the second liquid chamber 143. The second pump 142 suctions the second liquid in the second chamber 41 into the second liquid chamber 143 via the second suction port 144 and discharges the second liquid into the second flow path 141 via the second discharge port 145 by the rotation of the second impeller 146.

A second piping portion is connected to the second outlet 149 described above. The second liquid in the second housing portion 40 is supplied to the heating unit of the vehicle, which is the target of cooling or temperature adjustment by the second liquid, via the second outlet 149 and the piping portion by driving the second pump 142.

According to the vehicle tank 100 described above according to the present embodiment, the first wall 28 defining the first housing portion 20 housing the first liquid and the second wall 48 defining the second housing portion 40 which receives the second liquid heated outside by heat exchange with the heating unit of the vehicle and houses the received second liquid have the common wall 105 shared by the first housing portion 20 and the second housing portion 40. Thus, the first liquid housed in the first housing portion 20 can be heated by the second liquid housed in the second housing portion 40 via the common wall 105. Therefore, the first liquid in the first housing portion 20 can be heated without disposing a heat exchanger in the first housing portion 20.

In the present embodiment, the vehicle tank includes the heat-insulating wall 60 which surrounds the periphery of the first housing portion 20 and the second housing portion 40 and insulates the first housing portion 20 and the second housing portion 40 from the outside of the vehicle tank 100. Therefore, since the first housing portion 20 and the second housing portion 40 can be insulated from the outside by the heat-insulating wall 60, the first liquid in the first housing portion 20 can be heated more effectively by the second liquid in the second housing portion 40.

In addition, in the present embodiment, the vehicle tank includes the lid member 80 which closes the first opening 22 provided in the first housing portion 20 and opening in the first direction and the second opening 42 provided in the second housing portion 40 and opening in the first direction. The lid member 80 is formed with at least one of the first communication port through which the inside of the first housing portion 20 communicates with the outside and the second communication port through which the inside of the second housing portion 40 communicates with the outside. Accordingly, the first liquid can be caused to flow into and out of the first housing portion 20 via the first communication port, and the second liquid can be caused to flow into and out of the second housing portion 40 via the second communication port. Therefore, for example, even if the first communication port and the second communication port are not provided to penetrate the first wall 28 and the second wall 48, it is possible to easily cause each liquid to flow into and out of the first housing portion 20 and the second housing portion 40.

In the present embodiment, the periphery of the first housing portion 20 is surrounded by the second housing portion 40. Thereby, the heat of the second liquid in the second housing portion 40 can be easily transferred to the first liquid in the first housing portion 20, and the heat dissipation from the inside of the first housing portion 20 to the outside can be further limited. Therefore, the first liquid in the first housing portion 20 can be heated more effectively by the second liquid in the second housing portion 40.

### B. Second Embodiment

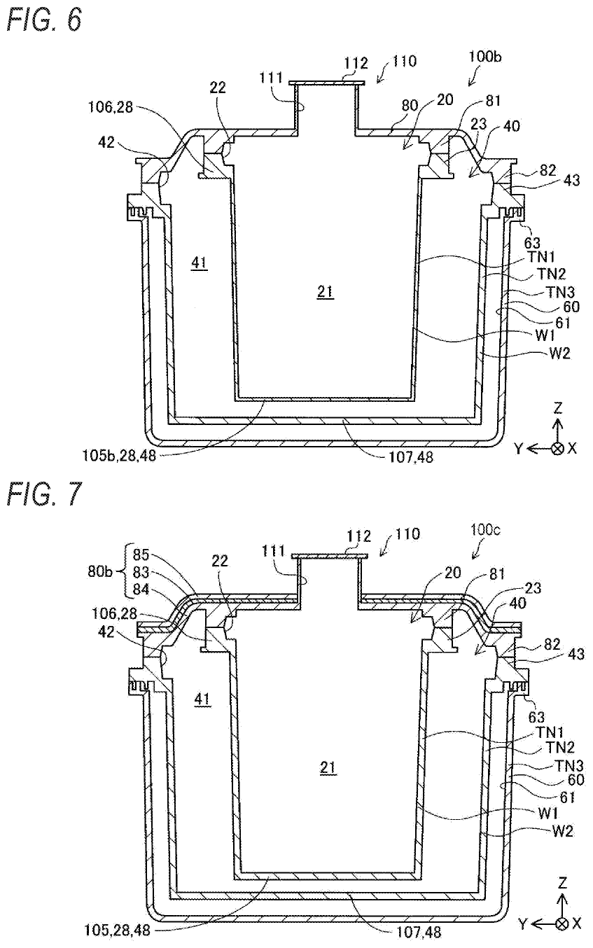

FIG. 6 is a cross-sectional view of a vehicle tank 100b according to a second embodiment. In the present embodiment, unlike the first embodiment, at least a portion of the common wall 105b is thinner than the second wall portion 107 of the second wall 48. The configuration of the vehicle tank 100b according to the second embodiment is the same as that in the first embodiment unless otherwise specified. In FIG. 6, as in FIGS. 3 to 5, the first liquid Lq1 and the second liquid Lq2 are omitted.

In the present embodiment, in the entire common wall 105b, the thickness of the common wall 105b is thinner than the thickness of the second wall portion 107 of the second wall 48. That is, in the present embodiment, a portion of the wall W1 of the heat-retention tank TN1 corresponding to the common wall 105b is formed thinner than the wall W2 of the heating tank TN2. The thickness of the common wall 105b according to the present embodiment is thinner than the thickness of the first wall portion 106 of the first wall 28 and thinner than the thickness of the heat-insulating wall 60.

According to the vehicle tank 100b of the second embodiment described above, at least a portion of the common wall 105b is thinner than the second wall portion 107 of the second wall 48. Thereby, the heat of the second liquid in the second housing portion 40 is easily transferred to the first liquid in the first housing portion 20 via the common wall 105b. Therefore, the first liquid in the first housing portion 20 can be heated more effectively by the second liquid in the second housing portion 40. In the present embodiment, as described above, the periphery of the first housing portion 20 and the second housing portion 40 are surrounded by the heat-insulating wall 60. Therefore, the influence on the strength of the vehicle tank 100 can be reduced even when the common wall 105b is made thin.

### C. Third Embodiment

FIG. 7 is a cross-sectional view of a vehicle tank 100c according to a third embodiment. In the present embodiment, unlike the first embodiment, the lid member 80b includes a heat-insulating portion 83 configured to insulate the first housing portion 20 and the second housing portion 40 from the outside. The configuration of the vehicle tank 100c in the third embodiment is the same as that in the first embodiment unless otherwise specified. In FIG. 7, as in FIGS. 3 to 5, the first liquid Lq1 and the second liquid Lq2 are omitted.

As illustrated in FIG. 7, the lid member 80b is formed by stacking a first member 84, the heat-insulating portion 83 described above, and a second member 85 in this order from the bottom. The first member 84 and the second member 85 have a recessed shape opening downward as a whole, and are formed of, for example, PP or the like similarly to the lid member 80 described in the first embodiment. In the present embodiment, the first protrusion 81 and the second protrusion 82 are formed integrally with the first member 84. Similar to the first member 84 and the second member 85, the heat-insulating portion 83 has a recessed shape which opens downward as a whole, and is formed of a heat-insulating material such as polyurethane, glass wool, or rock wool. The first member 84, the heat-insulating portion 83, and the second member 85 may be fixed to each other by, for example, a fixing tool such as a rivet or a bolt, or an adhesive. In addition, the end portion of the first member 84 and the end portion of the second member 85 may be fixed to each other by welding, or by an adhesive, a fixing tool, or the like, so that the heat-insulating portion 83 is held between the first member 84 and the second member 85.

In another embodiment, the lid member 80b may not include the second member 85, for example. In addition, by providing a space in the lid members 80b, the lid member 80b may function as a heat-insulating portion.

According to the vehicle tank 100c according to the third embodiment described above, the lid member 80b includes the heat-insulating portion 83 configured to insulate the first housing portion 20 and the second housing portion 40 from the outside. Accordingly, even when the first opening 22 and the second opening 42 are provided, the first housing portion 20 and the second housing portion 40 can be effectively insulated from the outside by the lid member 80b.

### D. Other Embodiments

(D1) In the above-described embodiment, the heat-insulating wall 60 insulates the first housing portion 20 and the second housing portion 40 from the outside by the air in the heat-insulating chamber 61. In contrast, for example, a heat-insulating material for insulating the first housing portion 20 and the second housing portion 40 from the outside may be provided in the heat-insulating chamber 61. Alternatively, the heat-insulating wall 60 itself may be made of a heat-insulating material such as polyurethane, glass wool, or rock wool. In this case, the heat-insulating chamber 61 may not be formed between the heat-insulating wall 60 and the second housing portion 40 or the like, and the heat-insulating wall 60 may be in contact with the second housing portion 40. More specifically, for example, the heat-insulating wall 60 may be configured by winding a heat-insulating material around the second housing portion 40. Alternatively, for example, the heat-insulating wall 60 may not be provided in the vehicle tank 100.

(D2) In the embodiment described above, both the first communication port and the second communication port are provided in the lid member 80, but one of the first communication port and the second communication port may be provided alone. Alternatively, for example, the lid member 80 may not be provided. In these cases, for example, a communication port through which the first liquid or the second liquid flows into and out of the vehicle tank 100 may be provided to penetrate the first wall 28 or the second wall 48.

(D3) In the above embodiment, the periphery of the first housing portion 20 is surrounded by the second housing portion 40. In contrast, the periphery of the first housing portion 20 may not be surrounded by the second housing portion 40. For example, the periphery of the second housing portion 40 may be surrounded by the first housing portion 20. In this case, among the first wall 28 and the second wall 48, a portion disposed between the first chamber 21 and the second chamber 41 and surrounded by the first chamber 21 functions as the common wall 105. In addition, the first housing portion 20 and the second housing portion 40 may be simply disposed to be in contact with each other in the X direction, the Y direction, and the Z direction. In this case, in the first wall 28 and the second wall 48, a portion sandwiched between the first chamber 21 and the second chamber 41 in the direction in which the first housing portion 20 and the second housing portion 40 are in contact with each other functions as the common wall 105.

(D4) In the above-described embodiment, the common wall 105 may have, for example, a plurality of irregularities protruding toward the first chamber 21 of the first housing portion 20 or the second chamber 41 of the second housing portion 40, or may have a wave shape. Thereby, the contact area between the first housing portion 20 and the second housing portion 40 in contact with each other via the common wall 105 increases, so that the first liquid in the first housing portion 20 can be heated more effectively by the second liquid in the second housing portion 40.

(D5) In the above embodiment, the vehicle tank 100 is disposed such that the inlet faces upward. In contrast, the vehicle tank 100 may not be disposed such that the inlet faces upward, as long as the vehicle tank 100 is configured to be capable of limiting unintended outflow of the liquid from the first housing portion 20 or the second housing portion 40. For example, the vehicle tank 100 may be disposed such that some or all of the inlets provided in the vehicle tank 100 are oriented in a direction along the X direction or the Y direction.

(D6) In the above embodiment, a plurality of vehicle tanks 100 may be provided in one vehicle.

The present disclosure is not limited to the embodiments described above, and can be realized by various configurations without departing from the gist of the present disclosure. For example, the technical features in the embodiments corresponding to the technical features in the aspects described in Summary of the Invention can be appropriately replaced or combined in order to solve a part or all of the problems described above or in order to achieve a part or all of the effects described above. Any of the technical features may be omitted as appropriate unless the technical feature is described as essential herein.

What is claimed is:

1. A vehicle tank, comprising:
a first housing portion configured to house a first liquid for cleaning a cleaning object; and
a second housing portion configured to receive a second liquid heated outside by heat exchange with a heating unit of a vehicle and house the second liquid which is received, wherein
a first wall defining the first housing portion and a second wall defining the second housing portion have a common wall shared by the first housing portion and the second housing portion.

2. The vehicle tank according to claim 1, further comprising:
a heat-insulating wall which surrounds a periphery of the first housing portion and the second housing portion, and insulates the first housing portion and the second housing portion from an outside.

3. The vehicle tank according to claim 1, wherein:
the first housing portion has a first opening which opens in a first direction;
the second housing portion has a second opening which opens in the first direction;
the vehicle tank further comprises a lid member configured to close the first opening and the second opening; and
the lid member has at least one of a first communication port through which an inside of the first housing portion communicates with the outside and a second communication port through which an inside of the second housing portion communicates with an outside.

4. The vehicle tank according to claim 3, wherein
the lid member includes a heat-insulating portion configured to insulate the first housing portion and the second housing portion from the outside.

5. The vehicle tank according to claim 1, wherein
the periphery of the first housing portion is surrounded by the second housing portion.

6. The vehicle tank according to claim 1, wherein:
the second wall has a wall portion different from the common wall; and
at least a portion of the common wall is thinner than the wall portion.
